(19) United States
(12) Patent Application Publication
(10) Pub. No.: US 2005/0033651 A1
(43) Pub. Date: Feb. 10, 2005

(54) Method and apparatus for on-line payment of a transaction in cash

(76) Inventors: Aleksander Kogan, St.Louis, MO (US); Gess Tukin, Maryland Heights, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/635,159

(22) Filed: Aug. 6, 2003

(51) Int. Cl. G06F 17/60

(52) U.S. Cl. 705/26

(57) ABSTRACT

An apparatus and method of purchasing a product or service from a site remote to the purchaser using the internet or another electronic medium using cash money. The purchaser first selects the product or service he wants to buy and determines its cash purchase price. The purchase then deposits dollar bills into a receptacle (L) located where the purchaser is located. Each bill is scanned as it is deposited to determine its face value and its serial number. The serial number is compared with a list of dollar bills to determine if the face value of the dollar bill corresponds with that of the listed dollar bill having that serial number. Once a count of the total value of deposited bills is sufficient to purchase the product or service, the seller is notified and the purchase is completed. The bills deposited are defaced or destroyed so they cannot be reused, but an account of the seller is credited with the deposited amount so he can access the funds.

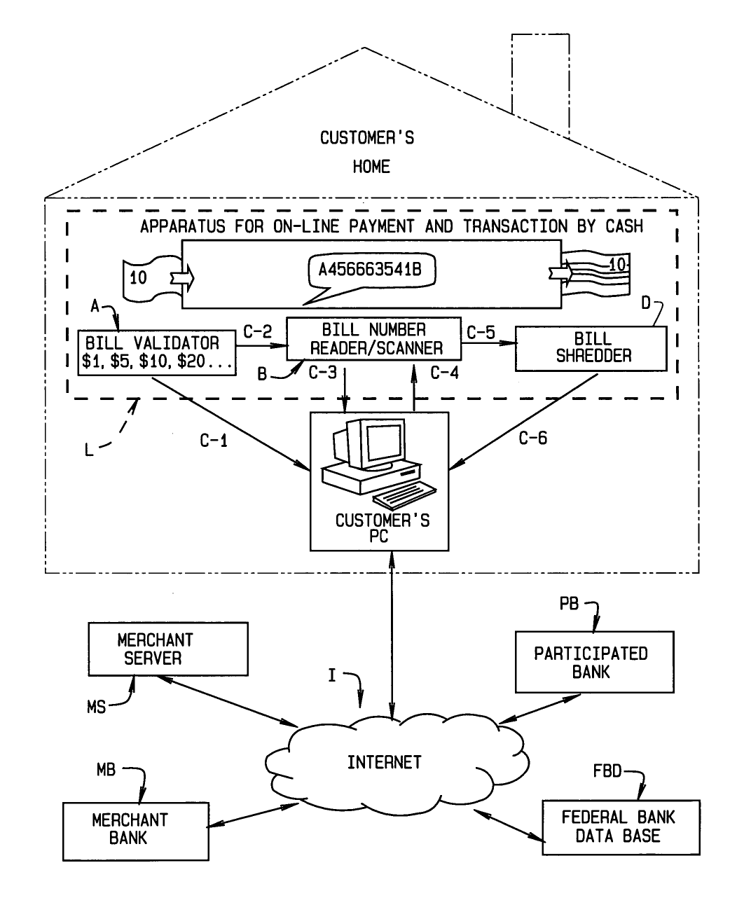

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to financial transactions conducted electronically; and more particularly, to a method and apparatus of conducting financial transactions over the internet or other commercial electronic medium, with the purchaser making an actual cash payment at the time of the transaction.

Electronic commercial transactions are well known in the art. A simple example of such a transaction is someone accessing an Internet website having a product for sale. Typically the person selects one or more items to purchase from a list of selections. A purchase screen then lists the total amount of the purchase, applicable taxes and shipping costs, and displays a grand total. If the purchaser agrees with the display, they indicate acceptance and a query display is presented as to the manner of payment. Payment is almost always by credit card so the purchaser has to supply his type of card (American Express, Mastercard, Visa, etc.) and account number to the seller. Alternatively, in some instances, the purchase is completed by an electronic funds transfer (EFT) or wire transfer from the buyer's account to an account of the seller.

All of this creates a number of problems. First, even though websites provide security to protect the names and credit card account numbers of their site users, the public record is replete with incidents of these sites being “hacked” into and account information stolen by people who then use the information to run up substantial unauthorized purchases. The same is also true of financial records kept by banks and the like, and the problem is costing billions of dollars of year, as well as many people having their credit records seriously damaged. While this damage can be ameliorated, this usually takes some time, and the credit card user often has to go through a substantial amount of effort to repair his credit history.

A second problem is that some people prize their anonymity and do not want to disclose information about themselves or their finances, even if the site to which they provide the information is truly secure. In most instances, whether the transaction is done using a credit card, EFT, or wire transfer, the financial transaction is directly traceable back to the buyer because of the information they have had to supply to make a purchase from a website or effect a monetary transfer, and many people are uncomfortable with this level of exposure.

Accordingly, the present invention is directed to a method and apparatus by which anyone can make a purchase of goods or services through an electronic medium using only cash, not credit cards, nor a bank account or other financial information about themselves, and the vendor can conduct such transactions with the knowledge he is fully protected financially when he conducts the transaction.

### BRIEF SUMMARY OF THE INVENTION

The present invention is directed to a method of purchasing a product or service from a site remote to the purchaser (via the internet or another electronic medium), the purchaser buying the product or service using cash money paid at the time of the transaction, rather than other forms of commercial exchange such as credit cards or electronic funds transfer. The purchaser first selects the product or service he wants to buy and determines its cash purchase price. The purchaser then deposits dollar bills into a receptacle located where the purchaser is located or (and) its indenticity and validity. Each bill is scanned as it is deposited to determine its face value and its serial number. Once a count of the total value of deposited bills is sufficient to purchase the product or service, the seller is notified and the purchase is completed. The bills deposited are defaced or destroyed so they cannot be reused, but an account of the seller is credited with the deposited amount and he can subsequently access the funds from a participating bank or other financial institution.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiment shown in the drawing which forms a part of the specification.

The sole FIGURE of drawings is a simplified representation of the method and apparatus of the invention.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

Referring to the drawing, a method and apparatus of the present invention is for purchasing a product or service from a site remote to the purchaser through a cash transaction conducted at the time of purchase. Typically, the purchaser or customer will use a personal computer or PC to access the internet I. The purchaser then selects a website for the merchant of an article, or articles, the purchaser wishes to buy. This is done through the seller's server MS. In some instances, rather than a product, the purchaser selects a service (a movie to watch or music to listen to, for example). In any event, once the product or service has been chosen, the cash purchase price of the product or service is determined.

While, heretofore, the purchaser has only had the option of using a credit card to make his purchase, the menu by which the purchaser selects his method of payment now includes a cash option. To facilitate a cash purchase, a receptacle or lock box L is installed at the purchaser's location. The lock box enables the purchaser to deposit cash, usually in the form of dollar bills of various denominations, into the lock box. However, once the dollar bills have been deposited they cannot be retrieved from it by the purchaser. For simplicity, as used herein, the term dollar bill means any type of currency capable of being used in conducting a transaction as described herein.

The lock box has three segments. First, is a bill reader and authenticator A. Devices for accepting and authenticating dollar bills are well known in the art and will not be described in detail. Typically such devices include a chute into which one end of the dollar bill is deposited. This usually requires the bill to be fed into the chute in a preferred orientation. For United States currency, this is most often with the face of the President or other historical figure imprinted on one face of the bill, submitted face-up. A motorized drive then draws the bill into the lock box, the bill being scanned as this is done. Authenticator A is programmed to determine whether or not the bill is authentic based upon a number of criteria which can include both pictorial (graphic) and textual information imprinted on the bill, as well as magnetic strips or verifying indicia woven into the paper stock from which the bill is produced. Besides determining the authenticity of the dollar bills deposited, authenticator A also reads the dollar amount represented by the bill. It will be understood that the bills can be of the same or different denominations.

As the amount of cash necessary to purchase the product or service is deposited into the receptacle, a signal C-1 is provided to the purchaser's PC by the authenticator indicating the amount of money deposited by the purchaser. This amount is displayed on the computer screen so the purchaser can see how much he has deposited. A signal can also be sent over the Internet to the merchant's website indicating the present amount of deposit. The display on the purchaser's PC, in addition to showing the amount presently deposited, can also display the amount of money which still needs to be deposited to cover the purchase price.

Once the dollar bills are authenticated, they are transferred from authenticator A to bill scanner B which reads the serial number on each bill and stores this information in a memory within the lock box. This transfer is indicated at C-2 in the drawing. Scanner B reads the face of each dollar bill and, in particular, the serial number of the bill. In the example shown in the drawing, this serial number is A456663451B. As is well known in the art, each dollar bill, regardless of denomination has a unique serial number. These serial numbers are maintained in a database such as a databank of the United States Treasury Department or the Federal Reserve System. In the drawing, this databank is indicated FBD.

As each dollar bill is scanned; or alternately, after all the dollar bills inserted in the lock box have been scanned, the serials numbers for each bill are transmitted over the Internet to the database. In the database, each serial number is separately searched to determine a) that the dollar bill is genuine and b) that the denomination associated with the dollar bill corresponds to the value stored in the database. If the database does not have a serial number corresponding to that scanned for a deposited bill, that is an indication the bill may be counterfeit. If so, then a reply signal is sent back to the purchaser's PC notifying the purchaser that this bill is unacceptable to complete the transaction. Similarly, if there is a corresponding serial number in the database, but the dollar amount stored in the database is different from that of the deposited bill, this, too, is an indication the bill may be counterfeit. Again, an indication is sent to the purchaser's PC indicating the bill is unacceptable to complete the purchase. Only if the serial number of the deposited bill, and its dollar amount, correspond to the information stored in the database is an indication given to the purchaser that the bill is accepted for completion of the purchase transaction. In the drawing, communication from the lock box to the purchaser's PC with the serial number and bill denomination is indicated C-3, and the reply from the database back to the PC and lock box is indicated C-4.

Once the amount of money deposited by the purchaser is sufficient to cover the purchase price, and the bills have been authenticated and verified, notification is sent, again via the Internet, to the merchant's bank MB. This notification, in effect, credits the merchant's account for the amount of the purchase price. A similar notification may be sent to the purchaser's bank PB. Since the transaction is a cash transaction, no debit is made to an account of the purchaser. However, the bank is notified of the serial number and denominations of the bills used by the purchaser to complete the transaction so to provide a confirmation as to the bills used in the transaction. This information can be compared with the information stored in the lock box memory. It is important to note that since purchaser confidentiality is an underlying purpose of the present invention, no information concerning the bills is provided to the purchaser. Only the fact that the appropriate amount sufficient to cover the purchase price has been paid and verified is provided; this being in the form of the communication crediting the seller's account.

Once the seller is notified that his account has been credited with the purchase price, the merchant then provides the product or service to the purchaser. If the purchase is an even dollar amount, then there is no need to make change, and the lock box is not equipped to give change. However, any difference between the purchase price and dollar amount deposited is credited to the depositor's account at participating bank PB. Also, any service fee charged by the bank to enable the transaction, and applicable taxes, are indicated on the purchaser's PC at the time he elects to use cash to make the purchase using the method of the present invention so the amount he must deposit covers these as well. There is no separate or follow-up transaction required. The service fee would be similar to that charged by a bank for using an ATM, and the taxes would include both taxes on the product or service purchased, and a tax on conducting the transaction, if applicable.

After it has been verified that the dollar bills deposited in the lock box are authentic and that the amount they represent equals the purchase price, the bills are sent from verifier B to a bill shredder indicated D as indicated by C-5 in the drawing. Shredder D, upon receipt of an indication that the transaction is either completed, or is in the process of completion, shreds the dollar bills supplied to it and sends an indication of completion of the shredding to the purchaser, the database FBD, and the purchaser's bank PB, as indicated at C-6. This effectively withdraws the bills from circulation so they cannot now be recovered by the purchaser, or anyone else, for further use.

Those skilled in the art will understand that other methods besides shredding can be used to remove the bills from circulation. For example, a stamp or printer can be used to print a legend such as “VOID” or “CANCELED” on the face of the bill. A color strip can be imprinted across the face of the bill, the strip being a sign to others that the bill is no longer legal tender.

In another embodiment of the invention, the purchaser can purchase a special scrip from his bank PB, paying for the scrip with dollar bills. The scrip would have both a denomination and serial number and would be used by the purchaser to make cash purchases over the Internet. The scrip could be used for no other purpose. Now, when a transaction is conducted, the bank's database, rather the federal bank's database, is checked to verify authenticity of the scrip. If no record is kept as to whom the scrip is issued, the transaction cannot be traced back to the purchaser.

After the transaction is completed, the merchant now has the amount of the purchase credited to his account. These funds are available to him at any time, and thee is nothing to trace the source of the funds back to the purchaser. At the same time, the purchaser's bank may be aware that he has made a purchase, but that is all. There is nothing by which the purchaser's account and that of the merchant can be tied together. The federal bank database is informed that bills having certain serial numbers have been withdrawn from circulation; but, again, there is nothing to directly tie the purchaser to the product or service he purchased. Transactional records may indicate that the purchaser used certain bills as part of a transaction, but not specifically what the purchase was. A record or receipt of the transaction can be printed for the purchaser so he has a record of what he purchased, when, and the dollar bills used to affect the purchase. If the purchaser has an appropriate financial program stored in his computer, a record can be entered there as well. Importantly, the record is made for, and is available only to the purchaser, and only if the purchaser elects to have a record made of the transaction. Otherwise, there is no tie between the purchaser and the purchase.

Those skilled in the art will understand that lock box L can be made as part of the purchaser's PC, or connected to it as a peripheral in the same manner as other peripherals such as printers. The lock box does not have to destroy or deface the currency inserted into it by the purchaser, but can be constructed so that once dollar bills are deposited into it they cannot be retrieved by the anyone other than an authorized personnel such as a bank employee. Regardless of whether deposited bills are destroyed, or defaced, or merely retained without alteration, the purchaser will periodically take the lock box to his bank or an approved financial institution. There, the lock box is opened and the deposited bills extracted. The lock box is then returned to the purchaser for his further use. Alternatively, an employee from a security company or the like can visit the purchaser's location and empty the lock box. This may be particularly convenient in certain locales such as office buildings or retirement homes where either a large number of lock boxes may be located in a small area, or where multiple users may have access to the lock box so a large amount of money may be deposited in the lock box.

Finally, it will be understood that while most transactions will only involve the currency of a particular country, US dollar bills, for example, purchase transaction can be completed using bills from two or more countries. In this embodiment, bill authenticator A is programmed to recognize currencies from different countries, the denomination of the currency and indicia by which each bill is uniquely identified. The federal database FDB, the database at a participating bank PB, or other database such one maintained by a national bank of each country, is appropriately accessed to take the information from bill verifier B and insure that both the bill and the denomination of the country which issued it. The purchaser's PC or the appropriate database is programmed with current exchange rates for foreign currencies. Now, if the bill is authentic, the purchaser is credited with converted value of the currency. Again, when the transaction is completed, the database for each country whose currency is used in completing the transaction is updated to indicate which bills are now withdrawn from circulation.

In view of the above, it will be seen that the several objects and advantages of the present invention have been achieved and other advantageous results have been obtained.

1. A method of purchasing a product or service from a site remote to the purchaser through a cash transaction, comprising:
selecting a product or service to be purchased from the remote site and determining the cash purchase price of the product or service;
depositing the amount of money, in cash, necessary to purchase the product or service into a receptacle located at the site of the purchaser;
verifying to a seller of the product or service that the amount of cash money deposited is sufficient to purchase the product or service; and,
providing the product or service to the purchaser once verification is received at the remote site that sufficient cash money has been deposited to at least equal the purchase price of the product or service.

2. The method of claim 1 wherein verifying the amount of cash money deposited includes:
determining that the cash money deposited into the receptacle is genuine;
counting the amount of money deposited; and,
providing an indication to both the purchaser and seller when the amount of money deposited is sufficient for purchase of the product or service.

3. The method of claim 2 in which the money deposited is in dollar bills and the method further includes:
scanning each dollar bill deposited to determine its face value, its serial number, and (or) its validity;
comparing the serial number on the dollar bill with a list of dollar bills to determine if the face value of the dollar bill corresponds with that of the listed dollar bill having that serial number; and,
counting the total value of the deposited bills.
crediting an account of the seller with the amount of cash money deposited by the purchaser;
invalidating the cash money deposited in the receptacle so it cannot be further used; and,
generating a list of the cash money deposited and credited to the account of the seller for the seller to subsequently obtain funds equal to the amount credited.

5. The method of claim 4 wherein invalidating the cash money includes defacing the money so it is no longer acceptable for cash transactions or exchange for other cash money or financial credit.

6. The method of claim 4 wherein invalidating the cash money includes destroying it.

7. The method of claim 3 in which a verification of the amount paid by the purchaser is retained by a financial institution in an account to which the seller has access in order to verify the amount of money available to the seller.

8. The method of claim 1 in which selecting a product or service to be purchased from the remote site and determining the cash purchase price of the product or service includes any fees charged by financial institutions to conduct the transaction.

9. The method of claim 8 further including any taxes charged for the product or service and for conducting the transaction.

10. The method of claim 1 further including crediting an account of the purchaser for any difference between the amount deposited and the total cost of the purchase.

11. The method of claim 1 in which the purchase transaction can be conducted using currency from more than one country.

12. The method of claim 11 including verifying the denomination of each country's currency deposited and crediting the purchase with the amount represented thereby based upon a current exchange rate between the country where the purchase transaction is being conducted and the country whose bills are deposited.

13. Apparatus for purchasing a product or service from a site remote to the purchaser through a cash transaction, comprising:
a personal computer having access to an electronic medium through a purchaser selects a product or service to be purchased from the remote site and determining the cash purchase price of the product or service;
a receptacle into which an amount of money, in cash, is deposited, the money covering the purchase price of product or service, and the receptacle located at a site convenient to the purchaser; and,
means providing the product or service to the purchaser once verification is received at the remote site that sufficient cash money has been deposited to at least equal the purchase price of the product or service

14. The apparatus of claim 13 in which the receptacle includes means verifying to the seller of the product or service that the amount of cash money deposited is sufficient to purchase the product or service.

15. The apparatus of claim 14 in which the receptacle further includes means scanning each dollar bill deposited to determine its face value and its serial number, the serial number on the dollar bill then being compared with a list of dollar bills to determine if the face value of the dollar bill corresponds with that of the listed dollar bill having that serial number.

16. The apparatus of claim 15 further including means counting the total value of the deposited bills.

17. The apparatus of claim 13 further including means invalidating the dollar bills so they can no longer be used after the purchase transaction is completed.

18. The apparatus of claim 17 in which the means invalidating the dollar bills includes means defacing the money so it is no longer acceptable for cash transactions or exchange for other cash money or financial credit.

19. The apparatus of claim 17 in which the means invalidating the dollar bills includes means destroying the bills.

20. The apparatus of claim 13 in which the receptacle includes means for verifying the currency from more than one country so the purchase transaction can be conducted using currency from at least two countries.
